(19) United States
(12) Patent Application Publication
(10) Pub. No.: US 2013/0216343 A1
(43) Pub. Date: Aug. 22, 2013

(54) CRANE

(71) Applicant: EPSILON Kran GmbH, (US)

(72) Inventor: Steindl JOHANNES, Elsbethen (AT)

(73) Assignee: EPSILON KRAN GMBH, Salzburg (AT)

(21) Appl. No.: 13/771,566

(22) Filed: Feb. 20, 2013

(30) Foreign Application Priority Data
Feb. 21, 2012 (EP) 12001151.5

(51) Int. Cl. B66C 13/12; B66C 23/70

(52) U.S. Cl. CPC B66C 13/12; B66C 23/701
USPC 414/680

(57) ABSTRACT

A device includes at least one telescopic crane jib having a boom and a boom extension. A working implement is fixed to the telescopic crane jib by a rotary joint arranged at the boom extension and which has two mutually spaced rotary bearings. Hydraulic lines lead from the boom between the spaced rotary bearings of the rotary joint to the working implement. In the region of that end of the boom extension, at which the rotary joint is arranged, is a guide or the hydraulic lines, which guides the hydraulic lines from the boom extension to the region between the spaced rotary bearings of the rotary joint.

The invention concerns a crane comprising at least one telescopic crane jib which has a boom and a boom extension, wherein a working implement is fixed to the telescopic crane jib by way of a rotary joint which is arranged at the boom extension and which has two mutually spaced rotary bearings, and hydraulic lines lead from the boom between the spaced rotary bearings of the rotary joint to the working implement, wherein provided in the region of that end of the boom extension, at which the rotary joint is arranged, is a guide means for the hydraulic lines, which guides the hydraulic lines from the boom extension to the region between the spaced rotary bearings of the rotary joint.

The invention further concerns a vehicle—in particular a wood harvester—comprising a crane having at least one telescopic crane jib according to at least one of the described embodiments.

Such cranes with at least one telescopic crane jib are already known. Thus for example EP 1 448 471 B1 shows such a crane in which the hydraulic lines extend on the top side of the boom and on the top side of the boom extension and are guided in a guide means in relation to the boom extension.

The object of the invention is to provide a crane which is improved over the state of the art, having at least one telescopic crane jib.

That object is attained by the features of claim 1.

The fact that arranged at the end of the jib, that is remote from the working implement, and at the end of the guide means, that is remote from the working implement, are fixing elements for the hydraulic lines, between which the hydraulic lines extend in the form of hydraulic hoses, means that, when the boom extension is fully extended, the hydraulic hoses move close to the boom and the boom extension whereby the telescopic crane jib is of a relatively small structure as the hydraulic lines no longer project far from the boom or the boom extension respectively.

In the state of the art in contrast, even when the boom extension is fully extended, the hydraulic lines are far away from the telescopic crane jib as the hydraulic hoses assume a U-shaped configuration in which they stand away from the crane jib, both in the retracted and also in the extended condition of the boom extension.

Further advantageous embodiments of the invention are defined in the appendant claims.

In that respect it is preferably provided that the guide means and the fixing elements for the hydraulic hoses are arranged at an underside of the boom extension and at an underside of the boom. The provision thereof at the underside of the boom extension and at the underside of the boom means that the hydraulic hoses can be better protected from environmental influences.

Protection is also claimed for a vehicle, in particular a wood harvester, comprising a crane having at least one telescopic crane jib according to at least one of the described embodiments.

Further details and advantages of the present invention will be described more fully hereinafter by means of the specific description with reference to the embodiments by way of example illustrated in the drawings in which:

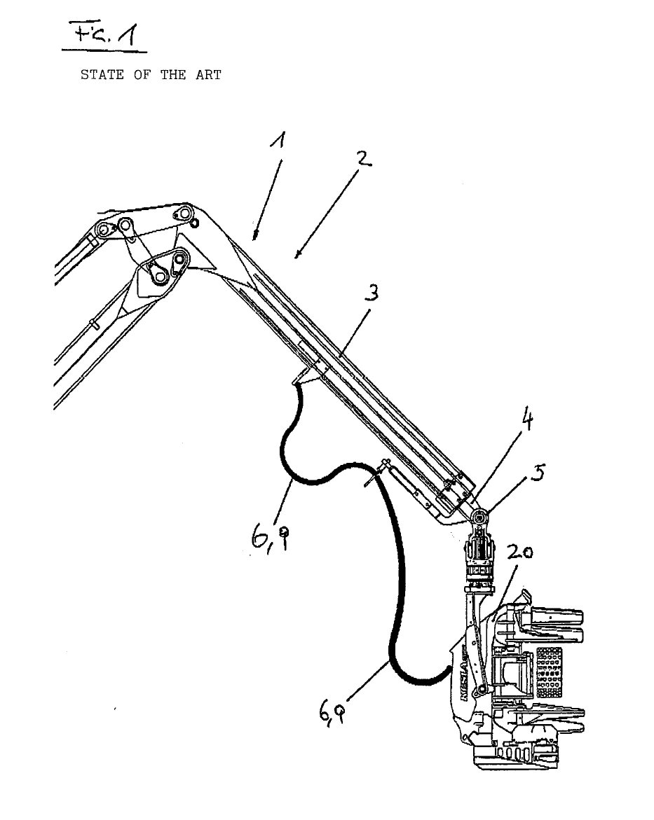

FIG. 1 shows a side view of a crane having a telescopic crane jib according to the state of the art,

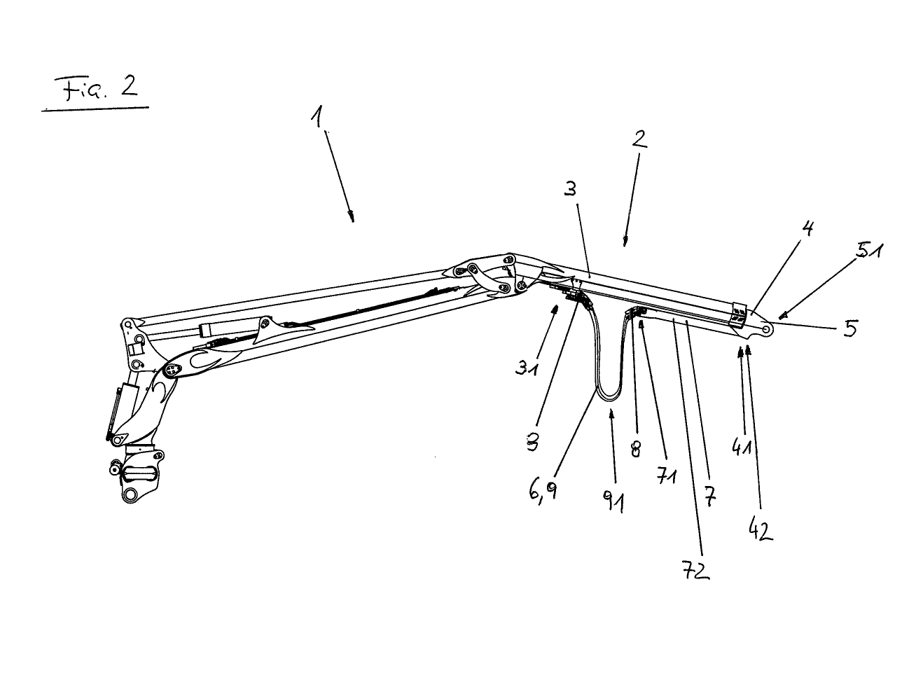

FIG. 2 shows a side view of a crane having a telescopic crane jib in the retracted condition,

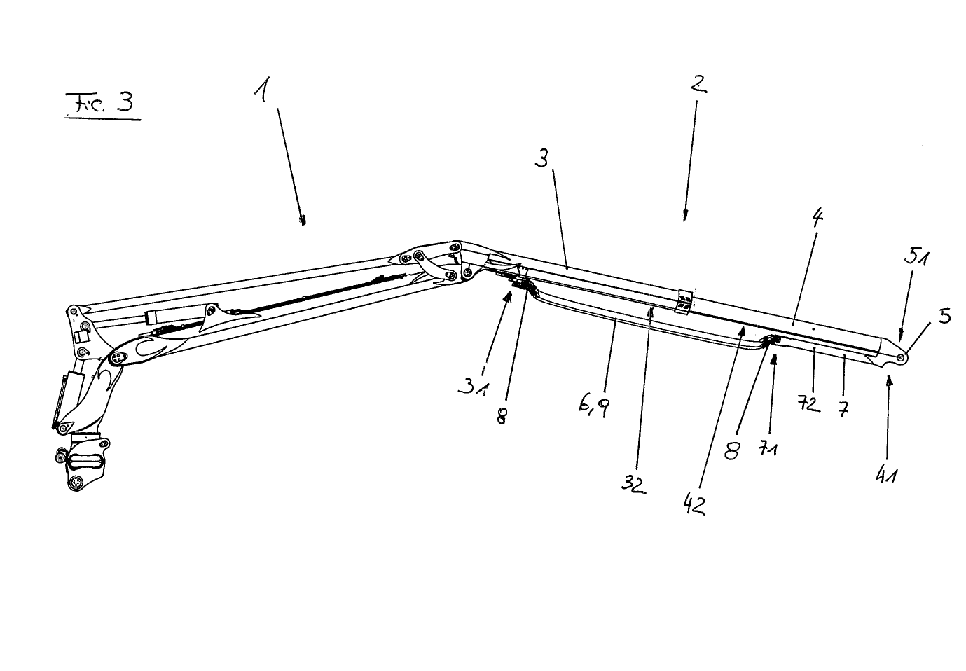

FIG. 3 shows a side view of a crane having a telescopic crane jib in the fully extended condition, and

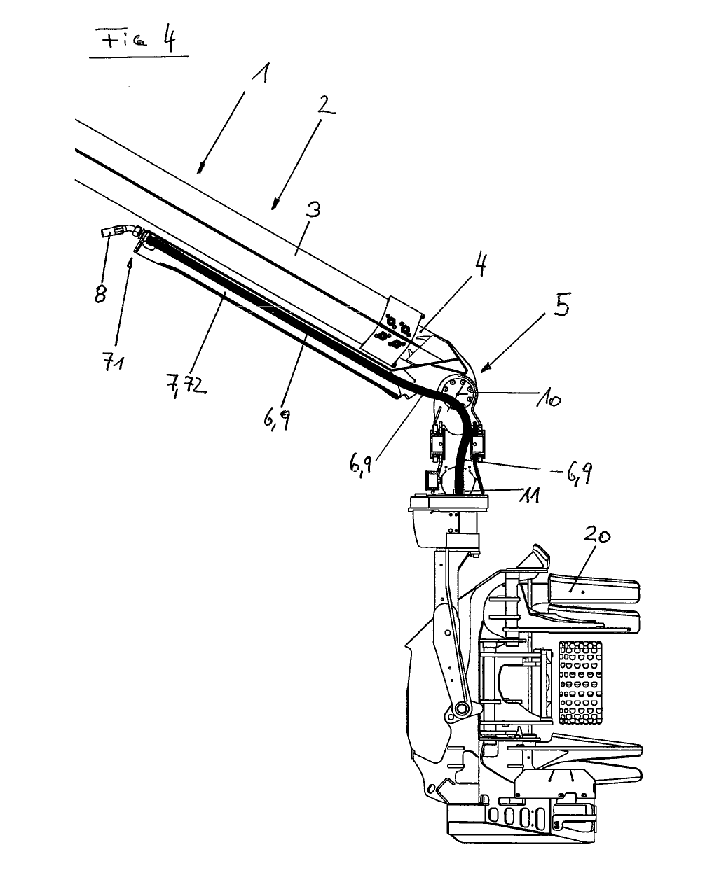

FIG. 4 shows a partial sectional side view of a crane having a telescopic crane jib.

FIG. 1 shows a telescopic crane 1 according to the state of the art. This crane 1 has the telescopic crane jib 2 having a boom 3 and a boom extension 4. Arranged at the boom extension 4 is a rotary joint 5 to which a working implement 20 is fixed.

The hydraulic lines 6 which are in the form of hydraulic hoses 9 extend from the boom 3 by way of a fixing location at the boom extension 4 to the working implement 20. In the state of the art those hydraulic lines 6 which are in the form of hydraulic hoses 9 extend in completely unprotected fashion and hang freely down, which, especially when manoeuvring the crane jib 2 and the working implement 20 in forest, can lead to damage to the hydraulic hoses 6.

FIG. 2 shows a side view of a crane 1. In this case the crane 1 has a telescopic crane jib 2 having a boom 3 and a boom extension 4, wherein a working implement (not shown here) can be fixed to the telescopic crane jib 2 by way of a rotary joint 5 which is arranged at the boom extension 4 and which has two mutually spaced rotary bearings, and hydraulic lines 6 lead from the boom 3 between the spaced rotary bearings of the rotary joint 5 to the working implement, wherein provided in the region of the end 41 of the boom extension 4, at which the rotary joint 5 is arranged, is a guide means 7 for the hydraulic lines 6, which guides the hydraulic lines 6 from the boom extension 4 to the region between the spaced rotary bearings of the rotary joint 5. In this case, arranged at the end 31 of the boom 3, that is remote from the working implement, and at the end 71 of the guide means 7, that is remote from the working implement, are fixing elements 8 for the hydraulic lines 6, between which the hydraulic lines 6 extend in the form of hydraulic hoses 9.

In this preferred embodiment the guide means 7 for the hydraulic lines 6 has a closed shaft 72 in which the hydraulic hoses 9 can extend. It will be appreciated that the shaft 72 could also be of an open configuration.

It will be appreciated that it can also be envisaged that the guide means 7 for the hydraulic lines 6 is not in the form of a shaft 72 but that said guide means 7 can have for example two bars which can guide the hydraulic hoses 9.

In addition it is further possible to envisage that the guide means 7 for the hydraulic lines 6 has one or more hoops in which the hydraulic hoses 9 can extend.

In this preferred embodiment the fixing elements 8 are in the form of screw means. It will be appreciated that it is also possible to envisage that the fixing elements 8 are in the form of hoops and the hydraulic hoses 9 extend freely therein and are held by said hoops.

It is further provided in a preferred embodiment that the guide means 7 and the fixing elements 8 for the hydraulic lines 9 are arranged at the underside 42 of the boom extension 4 and at the underside 32 of the boom 3, which is advantageous especially when the crane 1 is provided on a vehicle—such as for example a wood harvester (also referred to as a harvester)—as they are better protected beneath the crane jib 2.

When the boom extension 4 is fully retracted—as shown in this FIG. 2—the hydraulic hoses 9 form beneath the boom 3 a curve portion 91 in the form of an open loop which sags downwardly.

If now the boom extension 4 is fully extended, as is shown in FIG. 3, the hydraulic hoses 9 straighten out and extend substantially parallel to the boom 3 and substantially parallel to the boom extension 4.

That leads to a very narrow crane jib 2 and the hydraulic hoses 9 thereof, which is advantageous especially in operations in forest as it is possible to reduce the risk of the hydraulic hoses 9 being able to remain caught up on trees or branches, which could cause damage to the hydraulic hoses 9.

FIG. 4 shows a partly cross-sectional view of the way in which the hydraulic lines 9 extend in the guide means 7 to the rotary joint 5, wherein the hydraulic hoses 9 extend in the rotary joint 5 between the two mutually spaced rotary bearings 10 thereof (only one rotary bearing 10 is shown).

As a result the hydraulic hoses 9 are completely protected by the fixing element 8 there at—that is to say at the end 71 of the guide means 7, that is remote from the working implement—as far as the working implement 20. In this case the connection 11 of the hydraulic hoses 9 is implemented perpendicularly from above, whereby the connection 11 is also protected by way of the working implement 20.

The way in which the hydraulic lines 9 extend in the state of the art (see FIG. 1) is in contrast thereto, in which case both the run of the hydraulic lines 9 and also the connection thereof to the working implement 20 are completely unprotected.

1. A device comprising:
A crane comprising at least one telescopic crane jib which has a boom and a boom extension, wherein a working implement is fixed to the telescopic crane jib by way of a rotary joint which is arranged at the boom extension and which has two mutually spaced rotary bearings, and hydraulic lines lead from the boom between the spaced rotary bearings of the rotary joint to the working implement, wherein provided in the region of that end of the boom extension, at which the rotary joint is arranged, is a guide means for the hydraulic lines, which guides the hydraulic lines from the boom extension to the region between the spaced rotary bearings of the rotary joint, wherein arranged at the end of the boom, that is remote from the working implement, and the end of the guide means, that is remote from the working implement, are fixing elements for the hydraulic lines, between which the hydraulic lines extend in the form of hydraulic hoses.

2. The device according to claim 1 wherein at least one of the fixing elements is in the form of a hoop in which the hydraulic hoses extend.

3. The device according to claim 1 wherein the guide means for the hydraulic lines has one or more hoops in which the hydraulic hoses extend.

4. The device according to claim 1 wherein the guide means for the hydraulic lines have an open or closed shaft in which the hydraulic hoses extend.

5. The device according to claim 1 wherein the guide means for the hydraulic lines has two bars which guide the hydraulic hoses.

6. The device according to claim 1 wherein the guide means and the fixing elements for the hydraulic hoses are arranged at an underside of the boom extension and at an underside of the boom.

7. The device according to claim 1 wherein with the boom extension fully extended the hydraulic hoses extends substantially parallel to the boom and to the boom extension.

8. The device according to claim 1 wherein with the boom extension fully retracted the hydraulic hoses form below the boom a curve portion which sags downwardly.

9. A vehicle, in particular a wood harvester, comprising device having at least one telescopic crane jib according to claim 1.
